(19) United States
(12) Patent Application Publication
(10) Pub. No.: US 2023/0075302 A1
(43) Pub. Date: Mar. 9, 2023

(54) WINDOW-MOUNT BEAMFORMER ARRAY FOR 5G ACCESS POINTS

(71) Applicant: Mobix Labs, Inc., Irvine, CA (US)

(72) Inventors: Meysam Moallem, Irvine, CA (US); Manuchehr Neshat, Irvine, CA (US); Kwai Kwong Lam, Rancho Santa Margarita, CA (US)

(21) Appl. No.: 17/930,282

(22) Filed: Sep. 7, 2022

Related U.S. Application Data
(60) Provisional application No. 63/242,363, filed on Sep. 9, 2021.
(60) Provisional application No. 63/242,367, filed on Sep. 9, 2021.

(51) Int. Cl. H01Q 1/12; H01Q 1/46

(52) U.S. Cl. CPC H01Q 1/1271; H01Q 1/46

(57) ABSTRACT

A method of installing an antenna array module on a window includes adhering the antenna array module to the window and connecting the antenna array module to an external module via a cable. The cable may extend from one side of the window to the other. The antenna array module may include a substrate (e.g., a transparent substrate) and a plurality of antenna elements (e.g., meshed patches) on one or more layers of the substrate. Beamformer(s) and splitter/combiner(s) operably connected to the plurality of antenna elements may be embodied in the external module or in the antenna array module (e.g., in whole or in part in one or more integrated circuits on a surface of the substrate). The external module may output digital data derived from mm-wave, intermediate frequency (IF) and/or baseband signal(s) received from the antenna array module.

### CROSS-REFERENCE TO RELATED APPLICATIONS

This application relates to and claims the benefit of U.S. Provisional Application No. 63/242,363, filed Sep. 9, 2021 and entitled “WINDOW-MOUNT BEAMFORMER ARRAY FOR 5G ACCESS POINTS,” and U.S. Provisional Application No. 63/242,367, filed Sep. 9, 2021 and entitled “TRANSPARENT ANTENNA ARRAY FOR WINDOW-MOUNT BEAMFORMERS,” the disclosures of both of which are wholly incorporated by reference herein.

### STATEMENT RE: FEDERALLY SPONSORED RESEARCH/DEVELOPMENT

Not Applicable

### BACKGROUND

In 5G networks, the use of millimeter-wave (mm-wave) signals is highly desirable for increased bandwidth and network speed. Unfortunately, millimeter waves are highly attenuated when passing through most walls and other barriers and enclosures, making it difficult to make use of the benefits of mm-wave signals in indoor spaces such as homes, offices, and vehicles.

### BRIEF SUMMARY

The present disclosure contemplates various systems and methods for overcoming the above drawbacks accompanying the related art. One aspect of the embodiments of the present disclosure is a method of installing an antenna array module on a window such as a window made of glass or a transparent polymer such as polycarbonate, which may have a much lower attenuation than surrounding walls or other barriers. The method may comprise adhering the antenna array module to the window. The antenna array module may include a substrate, a plurality of antenna elements on one or more layers of the substrate, and one or more integrated circuits on a surface of the substrate. The substrate can have one or more metal layers (e.g., outer layers as well as inner layers), and the antenna elements may be implemented on one or more of the metal layer(s), for example. The one or more integrated circuits may include one or more beamformers operably connected to the plurality of antenna elements, e.g., via a splitter/combiner that is included in the integrated circuit(s) and/or embodied in a feed network of traces implemented on the substrate. The beamformer(s) and splitter/combiner may be provided so as to adjust phase and amplitude of a plurality of mm-wave signals received by the plurality of antenna elements and combine the adjusted mm-wave signals into a combined mm-wave signal in a receive mode and/or to split a mm-wave signal into a plurality of mm-wave signals and adjust phase and amplitude of the plurality of mm-wave signals to be transmitted respectively by the plurality of antenna elements in a transmit mode. The method may further comprise connecting the antenna array module to an external module via a cable. The external module may be operable, in a receive mode, to receive a signal from the one or more integrated circuits via the cable and output digital data derived therefrom. The external module may further be operable, in a transmit mode, to produce an input signal from digital data and provide the input signal to the one or more integrated circuits via the cable.

The adhering of the antenna array module to the window may be via an adhesive attached to the one or more integrated circuits. The antenna array module may include a molding on the surface of the substrate that covers the one or more integrated circuits, and the adhering of the antenna array module to the window may be via an adhesive attached to the molding. The adhering of the antenna array module to the window may be via an adhesive attached to the plurality of antenna elements. The antenna array module may include a superstrate (e.g., solder resist) on the substrate that covers the plurality of antenna elements, and the adhering of the antenna array module to the window may be via an adhesive attached to the superstrate.

The one or more integrated circuits may include one or more frequency converters operable, in a receive mode, to down-convert a mm-wave signal (e.g., a combined mm-wave signal output by the splitter/combiner and beamformer(s)) to produce a down-converted signal, and the signal received by the external module may be the down-converted signal. The down-converted signal may be a baseband signal, and the external module may be operable to derive the digital data from the baseband signal. The one or more frequency converters may further be operable, in a transmit mode, to up-convert a baseband signal to produce a mm-wave signal to be split by the splitter/combiner for transmission by the plurality of antenna elements.

In some embodiments, all or a portion of the frequency conversion functionality may instead reside in the external module rather than in the integrated circuit(s) of the antenna module. In this regard, it is contemplated that the down-converted signal received by the external module in a receive mode may be an intermediate frequency (IF) signal, the external module may include one or more frequency converters operable to convert the IF signal to a baseband signal, and the external module may be operable to derive the digital data from the baseband signal. Alternatively, the one or more frequency converters of the external module may be operable, in a receive mode, to down-convert a mm-wave signal (e.g., a combined mm-wave signal output by the splitter/combiner and beamformer(s)) to produce a baseband signal, and the external module may be operable to derive the digital data from the baseband signal. The one or more frequency converters of the external module may further be operable, in a transmit mode, to up-convert a baseband signal to produce a mm-wave signal to be split by the splitter/combiner for transmission by the plurality of antenna elements or to produce an IF signal that is further up-converted by frequency converter(s) of the integrate circuit(s) disposed on the antenna array module and thereafter split by the splitter/combiner for transmission by the plurality of antenna elements.

The substrate may be a printed circuit board (PCB). The antenna array module and the external module may be on opposite sides of the window, and the cable may extend through the window. The external module may include a media access controller (MAC).

Another aspect of the embodiments of the present disclosure is a method of installing an antenna array module on a window. The method may comprise adhering the antenna array module to the window. The antenna array module may include a transparent substrate and a plurality of antenna elements on one or more layers of the substrate. The method may further comprise connecting the antenna array module to an external module via a cable. The external module may include a beamformer and a splitter/combiner operably connected to the plurality of antenna elements of the antenna array module via the cable. The beamformer(s) and splitter/combiner may be provided so as to adjust phase and amplitude of a plurality of mm-wave signals received by the plurality of antenna elements and combine the adjusted mm-wave signals into a combined mm-wave signal in a receive mode and/or to split a mm-wave signal into a plurality of mm-wave signals and adjust phase and amplitude of the plurality of mm-wave signals to be transmitted respectively by the plurality of antenna elements in a transmit mode.

The adhering of the antenna array module to the window may be via an adhesive attached to the plurality of antenna elements. The antenna array module may include a superstrate (e.g., solder resist) on the transparent substrate that covers the plurality of antenna elements, and the adhering of the antenna array module to the window may be via an adhesive attached to the superstrate.

The external module may include one or more frequency converters operable, in a receive mode, to down-convert a mm-wave signal (e.g., a combined mm-wave signal output by the splitter/combiner and beamformer(s)) to produce a down-converted signal, and the external module may be operable to output digital data derived from the down-converted signal. The one or more frequency converters of the external module may further be operable, in a transmit mode, to up-convert a baseband signal to produce a mm-wave signal to be split by the splitter/combiner for transmission by the plurality of antenna elements.

The plurality of antenna elements may define a plurality of meshed patches over a meshed ground. Other contemplated types of antenna elements may include substrate-integrated antennas such as slot antennas, planar inverted-F antennas (PIFA), printed dipole or monopole antennas, magnetoelectric (ME) dipole antennas, printed loop antennas, and Vivaldi antennas, for example. The antenna array module and the external module may be on opposite sides of the window, and the cable may extend through the window. The external module may include a media access controller (MAC).

Another aspect of the embodiments of the present disclosure is a system for installing an antenna array module on a window. The system may comprise an antenna array module including a substrate and a plurality of antenna elements on one or more layers of the substrate, an adhesive for attaching the antenna array module to the window, and one or more beamformers and splitter(s)/combiner(s) operably connected to the plurality of antenna elements. The beamformer(s) and splitter(s)/combiner(s) may be provided so as to adjust phase and amplitude of a plurality of mm-wave signals received by the plurality of antenna elements and combine the adjusted mm-wave signals into a combined mm-wave signal in a receive mode and/or to split a mm-wave signal into a plurality of mm-wave signals and adjust phase and amplitude of the plurality of mm-wave signals to be transmitted respectively by the plurality of antenna elements in a transmit mode. The system may further comprise an external module connectable to the antenna array module via a cable. The external module may be operable, in a receive mode, to receive one or more signals from the antenna array module via the cable and output digital data derived therefrom. The external module may further be operable, in a transmit mode, to produce an input signal from digital data and provide the input signal to the antenna array module via the cable.

The beamformer(s) may be included in one or more integrated circuits disposed on a surface of the substrate, and the splitter/combiner may likewise be included in the integrated circuit(s) and/or embodied in a feed network of traces implemented on the substrate. The one or more signals received by the external module in the receive mode may comprise a combined mm-wave signal output by the splitter/combiner and beamformer(s) or a down-converted baseband or IF signal derived therefrom. In the transmit mode, the input signal produced by the external module may comprise a mm-wave signal to be split and adjusted for output as a plurality of mm-wave signals by the plurality of antenna elements or may be a baseband or IF signal to be up-converted and subsequently split and adjusted for output. Alternatively, the beamformer (and in some cases the splitter/combiner as well) may be included in the external module. In this case, the one or more signals received by the external module in the receive mode may comprise a plurality of mm-wave signals received by the plurality of antenna elements, and the input signal produced by the external module in the transmit mode may comprise a plurality of mm-wave signals to be output by the plurality of antenna elements.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a system for installing an antenna array module on a window according to an embodiment of the present disclosure;

FIG. 2 shows another system for installing an antenna array module on a window;

FIG. 3 shows another system for installing an antenna array module on a window;

FIG. 4 shows another system for installing an antenna array module on a window; and

FIG. 5 shows another system for installing an antenna array module on a window.

### DETAILED DESCRIPTION

The present disclosure encompasses various embodiments of systems and methods for installing an antenna array module on a window. The disclosed systems and methods may enable 5G mm-wave access points in indoor spaces including homes, offices, and vehicles. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

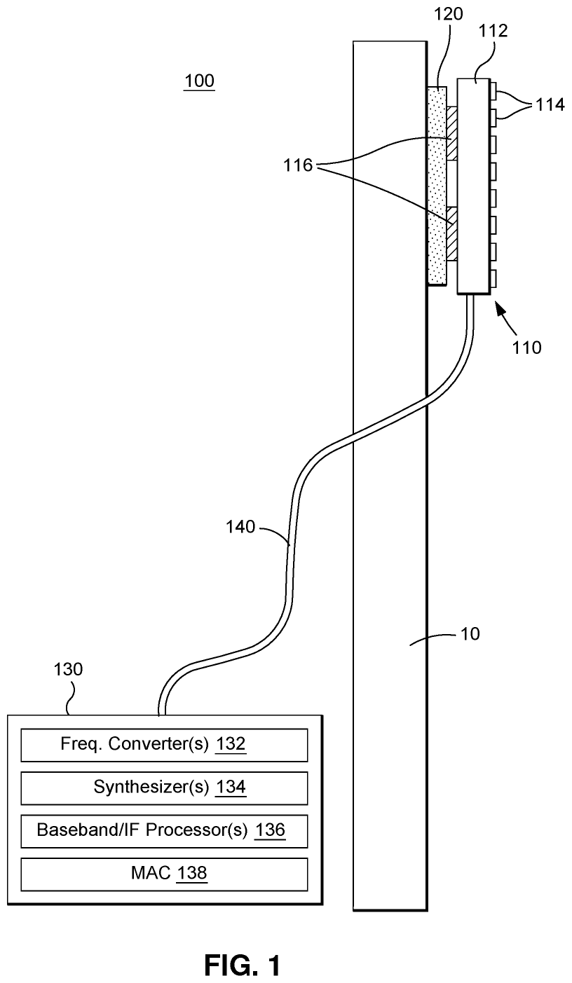

FIG. 1 shows a system 100 for installing an antenna array module 110 on a window 10 according to an embodiment of the present disclosure. In FIG. 1 (and in all of FIGS. 1 through 5), the left-hand side of the window 10 may represent the inside of an indoor space such as a home, office, or vehicle, with the right-hand side representing the outside thereof. In the example of FIG. 1, the antenna array module 110, which includes a substrate 112 such as a printed circuit board (PCB) and a plurality of antenna elements 114 on one or more layers thereof (e.g., on an outward facing surface in the illustrated example), is mounted on the outside of the window 10 using an adhesive 120. Because the antenna elements 114 are outside the window 10, the attenuation typically experienced by mm-wave signals traveling to and from the indoor space may be significantly reduced. At the same time, in order not to expose sensitive and expensive electronics to weather and possible damage or theft, the system 100 further includes an external module 130 that may be disposed on the inside of the window 10 and connected to the antenna array module 110 by a cable 140 that extends through the window 10. The cable 140 may extend through the window 10 by being passed through the window 10 via a small opening made therein or by being routed around its edges, for example.

The external module 130 may house various functionalities (e.g., embodied in one or more integrated circuits) that would conventionally be housed together with the antenna elements 114 and may be operable to output digital data derived from signals received over the cable 140 from the antenna array module 110 (and/or, in the case of transmission rather than reception, to provide signals derived from input digital data to the antenna array module 110 over the cable 140). In this way, the system 100 may serve as a 5G mm-wave access point for an indoor space separated from the outside by the window 10. In the example of FIG. 1, the external module 130 includes, optionally, all or a portion of the frequency converter(s) 132, synthesizer(s) 134, and baseband and/or intermediate frequency (IF) processor(s) 136 (e.g., modem) associated with conversion between millimeter-wave signals and digital data, along with a media access controller (MAC) 138 (though frequency converter(s) 132 and synthesizer(s) 134 may instead be included in the antenna array module 110 as described below). The antenna array module 110 in turn includes one or more integrated circuits 116 embodying the beamformer(s) that are operatively associated with the array of antenna elements 114 via one or more splitter(s)/combiner(s), which may likewise be included in the integrated circuit(s) 116 and/or embodied in a feed network of traces implemented on the substrate 112. In particular, the integrated circuit(s) 116, which may be disposed on a surface of the substrate 112 (e.g., on an inward facing surface opposite the outward facing surface in the illustrated example), may include one or more beamformers operable to adjust phase and amplitude of a plurality of mm-wave signals received by the plurality of antenna elements 114 (or to be transmitted by the plurality of antenna elements 114). The splitter(s)/combiner(s) may be operable to combine the adjusted mm-wave signals into a combined mm-wave signal (or to split a mm-wave signal into a plurality of mm-wave signals to be transmitted). In the example of FIG. 1, the antenna array module 110 is adhered to the window 10 via an adhesive 120 attached to the one or more integrated circuits 116, allowing the antenna elements 114 on the opposite side of the substrate 112 to be minimally impacted by the adhesive 120. The adhesive 120 may be an adhesive tape or film, for example, and may comprise a pressure sensitive adhesive (PSA).

As indicated above, the integrated circuit(s) 116 included in the antenna array module 110 may in some cases share the frequency conversion functionality with the external module 130 (or be entirely responsible for the frequency conversion functionality). For example, the integrated circuit(s) 116 may include one or more frequency converters operable to down-convert the mm-wave signal to produce a down-converted signal that is an IF signal, with the external module including the one or more frequency converters 132 for converting the IF signal to a baseband signal. It is also contemplated that the frequency converter(s) of the integrated circuit(s) 116 may down-convert the mm-wave signal all the way to the baseband signal, in which case the frequency converter(s) 132 and/or synthesizer(s) 134 of the external module 130 may not be necessary. Alternatively, the frequency conversion functionality may be entirely performed by the external module 130. In this case, only the beamformer(s) and splitter(s)/combiner(s) may be embodied in the antenna array module 110, with all frequency converter(s) 132 and synthesizer(s) 134 being in the external module 130. In this case, the mm-wave signal itself may be transferred by the cable 140. By limiting the functionality of the integrated circuit(s) 116 included with the antenna array module 110, routing on the substrate 112 can be greatly simplified and the complexity of the laminate design can be reduced accordingly.

The cable 140 may be capable of supporting high-speed and high-frequency signals and may be transparent so as not to obstruct the window 10. The cable 140 may be an optical waveguide with a flexible printed circuit board (OFPC), for example. OFPC cables may enable low loss signal transfer (e.g., between beamformer and processor) for long distances, which may be key for indoor automotive applications, for example. The same cable 140 may be used to power the devices on the substrate 112 of the antenna array module 110.

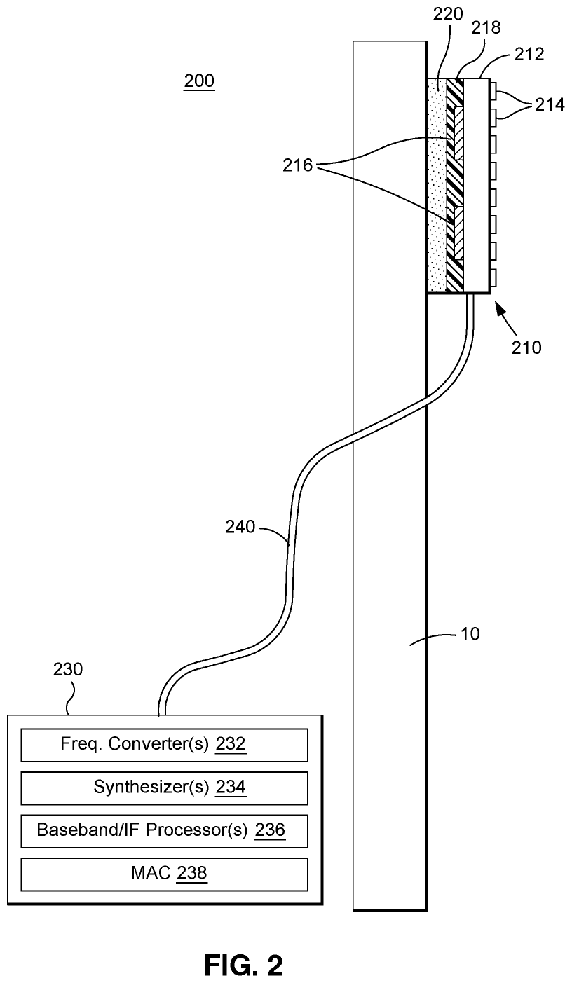

FIG. 2 shows another system 200 for installing an antenna array module 210 on a window 10. The system 200 may be the same as the system 100 except as described below and may similarly include an antenna array module 210 having a substrate 212, antenna elements 214, and integrated circuit(s) 216 that are the same as the antenna array module 110 having the substrate 112, antenna elements 114, and integrated circuit(s) 116 except as indicated, as well as an external module 230 having optional frequency converter(s) 232, synthesizer(s) 234, baseband and/or IF processor(s) 236, and MAC 238 that are the same as the external module 130 having the optional frequency converter(s) 132, synthesizer(s) 134, baseband and/or IF processor(s) 136, and MAC 138. The antenna array module 220 and external module 230 may similarly be connected by a cable 240 that is the same as the cable 140 and may similarly extend through the window 10. The system 200 differs from the system 100 in the manner in which the antenna array module 210 is adhered to the window 10. Whereas the antenna array module 110 of FIG. 1 is adhered by an adhesive 120 attached to the integrated circuit(s) 116, the antenna array module 210 is instead adhered to the window 10 by an adhesive 220 that is attached to a molding 218 that is formed on the inward facing surface of the substrate 212 so as to cover the integrated circuit(s) 216. For example, the substrate 212 (which may be made of PCB laminate, for example) may be over-molded to create a level surface covering the integrated circuit(s) 216, and the adhesive 220 may be attached to the molding 218 on one side and to the window 10 on the other. This may result in a more reliable adhesion between the antenna array module 110 and the window 10.

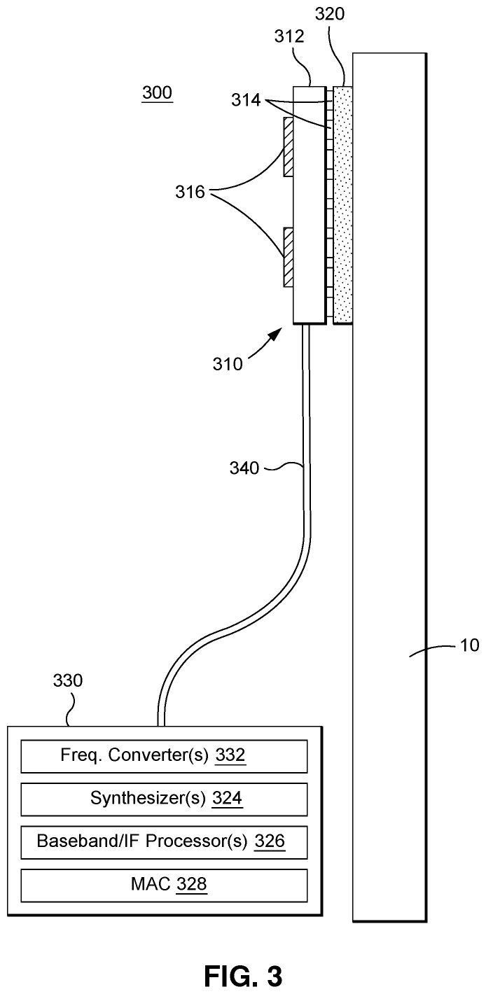

FIG. 3 shows another system 300 for installing an antenna array module 310 on a window 10. The system 300 may be the same as the system 100 except as described below and may similarly include an antenna array module 310 having a substrate 312, antenna elements 314, and integrated circuit(s) 316 that are the same as the antenna array module 110 having the substrate 112, antenna elements 114, and integrated circuit(s) 116 except as indicated, as well as an external module 330 having optional frequency converter(s) 332, synthesizer(s) 334, baseband and/or IF processor(s) 336, and MAC 338 that are the same as the external module 130 having the optional frequency converter(s) 132, synthesizer(s) 134, baseband and/or IF processor(s) 136, and MAC 138. The antenna array module 320 and external module 330 may similarly be connected by a cable 340 that is the same as the cable 140, except that in the example of FIG. 3 the cable 340 does not extend through the window 10 because the antenna array module 310 and external module 330 are on the same side of the window 10. In this regard, the system 300 differs from the system 100 in the manner in which the antenna array module 310 is adhered to the window 10. Whereas the antenna array module 110 of FIG. 1 is adhered by an adhesive 120 attached to the integrated circuit(s) 116, the antenna array module 310 is instead adhered to the window 10 by an adhesive 320 that is attached to the plurality of antenna elements 314. In this way, the antenna array module 310 may be adhered to the window 10 at its front or outward-facing side, with both the antenna array module 310 and the external module 330 being on the inside of the window 10. Because millimeter waves may pass through windows (e.g., glass) with minimal attenuation, the system 300 may still allow for a 5G mm-wave access point in the indoor space. On the other hand, to the extent that the signal received or transmitted by the antenna elements 314 may be impacted by the adhesive 320 and/or window 10, it is contemplated that the system 300 may preferably be optimized to take into consideration the effect of the adhesive 320 or window 10. To this end, the array of antenna elements 314 may be designed with these or similar dielectric layers in place (e.g., on top of the antenna elements 314) in order to simulate the eventual installation of the antenna array module 310 on an actual window 10.

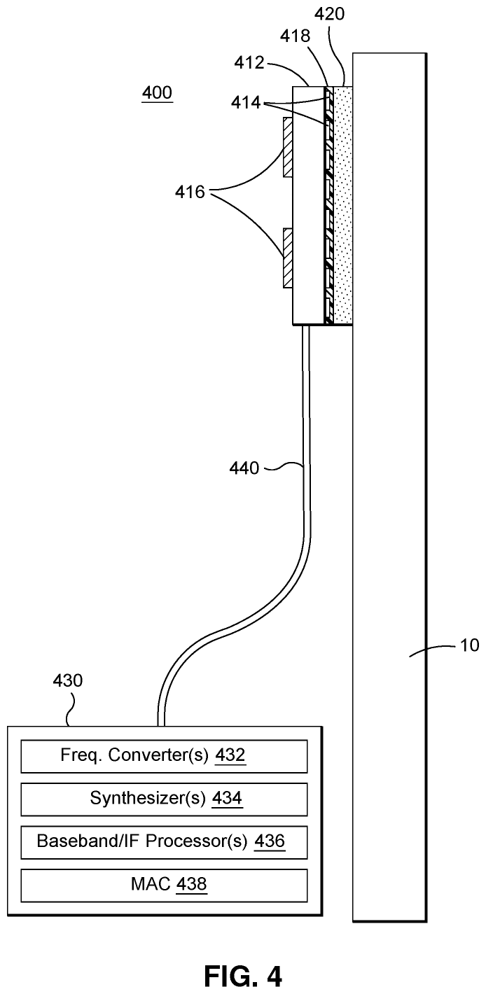

FIG. 4 shows another system 400 for installing an antenna array module 410 on a window 10. The system 400 may be the same as the system 100 except as described below and may similarly include an antenna array module 410 having a substrate 412, antenna elements 414, and integrated circuit(s) 416 that are the same as the antenna array module 110 having the substrate 112, antenna elements 114, and integrated circuit(s) 116 except as indicated, as well as an external module 430 having optional frequency converter(s) 432, synthesizer(s) 434, baseband and/or IF processor(s) 436, and MAC 438 that are the same as the external module 130 having the optional frequency converter(s) 132, synthesizer(s) 134, baseband and/or IF processor(s) 136, and MAC 138. The antenna array module 420 and external module 430 may similarly be connected by a cable 440 that is the same as the cable 140, except that in the example of FIG. 4, similar to in the example of FIG. 3, the cable 440 does not extend through the window 10 because the antenna array module 410 and external module 430 are on the same side of the window 10. In this regard, the system 400 is largely the same as the system 300 and only differs from the system 300 in the manner in which the antenna array module 410 is adhered to the window 10. Whereas the antenna array module 310 of FIG. 3 is adhered by an adhesive 320 attached to the plurality of antenna elements 314, the antenna array module 410 is instead adhered to the window 10 by an adhesive 420 that is attached to a superstrate 418 that is formed on the outward facing surface of the substrate 412 so as to cover the antenna elements 414. For example, a solder resist or solder mask may define a superstrate 418 on the substrate 412 (which may be made of PCB laminate, for example) that creates a level surface covering the antenna elements 414, and the adhesive 420 may be attached to the superstrate 418 on one side and to the window 10 on the other. This may result in a more reliable adhesion between the antenna array module 110 and the window 10. In this way as well, the antenna array module 410 may be adhered to the window 10 at its front or outward-facing side, with both the antenna array module 410 and the external module 430 being on the inside of the window 10. Because millimeter waves may pass through windows (e.g., glass) with minimal attenuation, the system 400 may likewise allow for a 5G mm-wave access point in the indoor space. On the other hand, to the extent that the signal received or transmitted by the antenna elements 414 may be impacted by the superstrate 418, the adhesive 420, and/or window 10, it is contemplated that the array of antenna elements 414 may be designed with these or similar dielectric layers in place in order to simulate the eventual installation of the antenna array module 410 on an actual window 10.

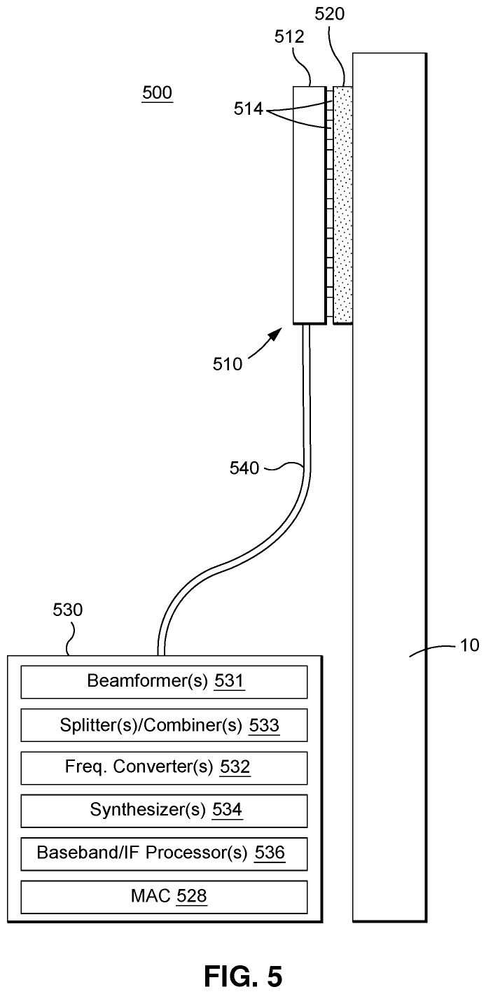

FIG. 5 shows another system 500 for installing an antenna array module 510 on a window 10. The system 500 may be the same as the system 300 shown in FIG. 3 except as described below and may similarly include an antenna array module 510 having a substrate 512 and antenna elements 514 that are the same as the antenna array module 310 having the substrate 312 and antenna elements 314 except as indicated. The antenna array module 510 may similarly be adhered to the window 10 by an adhesive 520 attached to the plurality of antenna elements 514. The system 500 may further include an external module 530 having frequency converter(s) 532, synthesizer(s) 534, baseband and/or IF processor(s) 536, and MAC 538 that are the same as the external module 330 having the optional frequency converter(s) 332, synthesizer(s) 334, baseband and/or IF processor(s) 336, and MAC 338 except as indicated. The antenna array module 510 and external module 530 may similarly be connected by a cable 540 that is the same as the cable 340, the antenna array module 510 and external module 530 similarly being on the same side of the window 10 in the illustrated example. The system 500 differs from the system 300 in that it is designed to be transparent, which is highly desirable for indoor including automotive beamformer applications. In particular, the antenna array module 510 of the system 500 may be mounted on a vehicle windshield or other window 10 without blocking the line of sight of a driver, passenger, or other person.

The transparency of the antenna array module 510 may be achieved by a combination of several features. First, as shown in FIG. 5 (in comparison with FIG. 3), the antenna array module 510 lacks the integrated circuits 316 which would otherwise present an obstruction. Instead, the beamformer and splitter/combiner functionality is included in the external module 530, which is depicted as including beamformer(s) 531 and splitter(s)/combiner(s) 533, accordingly. In this regard, it is contemplated that the cable 540 (e.g., OFPC) may transfer a number of mm-wave signals equal to the number of antenna elements 514 between the antenna array module 510 and the external module 530. Second, the substrate 510 on which the antenna elements 512 are mounted may be made of a transparent material such as glass. Routing of mm-wave signals to/from the antenna elements 512 may be done on the transparent substrate 510 (e.g., on the edge thereof). Third, the array of antenna elements 512 may itself be transparent. To this end, the plurality of antenna elements 514 may define a plurality of meshed patches over a meshed ground, for example, which may allow for an effective transparency of the array that may depend on mesh size and may be tailored to the transparency requirements of the particular application. Examples of such a transparent array of antenna elements 512 may be found in B. Xi, et. al. “Optical Transparent Antenna Array Integrated With Solar Cell,” IEEE ANTENNAS AND WIRELESS PROPAGATION LETTERS, VOL. 19, NO. 3, Mar. 2020, the entire contents of which is incorporated by reference herein. Fourth, a transparent adhesive 520 such as an acrylic-based adhesive may be used. Fifth, the cable 540 may be made of a transparent material such as a transparent OFPC. By implementing some or all of these features, the system 500 may allow for transparent window-mounting of beamformers for 5G mm-wave access points in indoor spaces.

The specific examples illustrated in FIGS. 1-5 depict a window 10 on which the antenna array module 110, 210, 310, 410, 510 is mounted. The window 10 may be made of glass or transparent plastic, for example. However, the systems 100, 200, 300, 400, 500 described are not necessarily limited to use with a window 10. For example, in the case of FIGS. 1 and 2, the antenna array module 110, 210 is mounted on the outside of the window 10, making the ability of mm-wave signals to pass through the window 10 less important for purposes of building a 5G mm-wave access point in the indoor space. Thus, it is contemplated that the same system 100, 200 may be usable not only with windows 10 but with external walls, barriers, and enclosures of various materials.

In the above examples, a single antenna array module 110, 210, 310, 410, 510 is illustrated in connection with a single external module 130, 230, 330, 430, 530. However, the disclosed subject matter is not intended to be so limited. For example, a single external module 130, 230, 330, 430, 530 may be provided as a hub for multiple antenna array modules 110, 210, 310, 410, 510, each connected by a separate cable 140, 240, 340, 440, 550 for example.

Throughout the above examples, both signal reception (mm-wave signals being received by the array of antenna elements and converted into digital data) and signal transmission (digital data being converted into mm-wave signals to be transmitted by the array of antenna elements) are described. However, it is contemplated that any of the systems 100, 200, 300, 400, 500 described herein may be designed for use in both reception and transmission modes or alternatively may be designed for use in only a single reception or transmission mode.

Throughout this disclosure, the word “transparent” is used broadly to encompass any materials that can be seen through. The word “transparent” is not intended to exclude translucent, hazy, frosted, colored, or tinted materials.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of installing an antenna array module on a window, the method comprising:
adhering the antenna array module to the window, the antenna array module including a substrate, a plurality of antenna elements on one or more layers of the substrate, and one or more integrated circuits on a surface of the substrate, the one or more integrated circuits including a beamformer operably connected to the plurality of antenna elements; and
connecting the antenna array module to an external module via a cable, the external module operable to receive a signal from the one or more integrated circuits via the cable and output digital data derived therefrom.

2. The method of claim 1, wherein said adhering is via an adhesive attached to the one or more integrated circuits.

3. The method of claim 1, wherein the antenna array module further includes a molding on the surface of the substrate that covers the one or more integrated circuits, and said adhering is via an adhesive attached to the molding.

4. The method of claim 1, wherein said adhering is via an adhesive attached to the plurality of antenna elements.

5. The method of claim 1, wherein the antenna array module further includes a superstrate on the substrate that covers the plurality of antenna elements, and said adhering is via an adhesive attached to the superstrate.

6. The method of claim 1, wherein the one or more integrated circuits further includes one or more frequency converters operable to down-convert a mm-wave signal to produce a down-converted signal, and the signal received by the external module is the down-converted signal.

7. The method of claim 6, wherein the down-converted signal is a baseband signal, and the external module is operable to derive the digital data from the baseband signal.

8. The method of claim 6, wherein the down-converted signal is an intermediate frequency (IF) signal, the external module includes one or more frequency converters operable to convert the IF signal to a baseband signal, and the external module is operable to derive the digital data from the baseband signal.

9. The method of claim 1, wherein the external module includes one or more frequency converters operable to down-convert a mm-wave signal to produce a down-converted signal, and the external module is operable to derive the digital data from the down-converted signal.

10. The method of claim 1, wherein the substrate is a printed circuit board (PCB).

11. The method of claim 1, wherein the antenna array module and the external module are on opposite sides of the window, and the cable extends through the window.

12. The method of claim 1, wherein the external module further includes a media access controller (MAC).

13. A method of installing an antenna array module on a window, the method comprising:
adhering the antenna array module to the window, the antenna array module including a transparent substrate and a plurality of antenna elements on one or more layers of the substrate; and
connecting the antenna array module to an external module via a cable, the external module including a beamformer and a splitter/combiner operably connected to the plurality of antenna elements of the antenna array module via the cable.

14. The method of claim 13, wherein said adhering is via an adhesive attached to the plurality of antenna elements.

15. The method of claim 13, wherein the antenna array module further includes a superstrate on the transparent substrate that covers the plurality of antenna elements, and said adhering is via an adhesive attached to the superstrate.

16. The method of claim 13, wherein the external module further includes one or more frequency converters operable to down-convert a mm-wave signal to produce a down-converted signal, and the external module is operable to output digital data derived from the down-converted signal.

17. The method of claim 13, wherein the plurality of antenna elements define a plurality of meshed patches over a meshed ground.

18. The method of claim 13, wherein the antenna array module and the external module are on opposite sides of the window, and the cable extends through the window.

19. The method of claim 13, wherein the external module further includes a media access controller (MAC).

20. A system for installing an antenna array module on a window, the system comprising:
an antenna array module including a substrate and a plurality of antenna elements on one or more layers of the substrate;
an adhesive for attaching the antenna array module to the window;
a beamformer and a splitter/combiner operably connected to the plurality of antenna elements; and
an external module connectable to the antenna array module via a cable, the external module being operable to receive one or more signals from the antenna array module via the cable and output digital data derived therefrom.

21. The system of claim 20, wherein the beamformer is included in one or more integrated circuits disposed on a surface of the substrate, and the one or more signals received by the external module comprise a combined mm-wave signal produced by the beamformer and splitter/combiner.

22. The system of claim 20, wherein the beamformer and the splitter/combiner are included in the external module, and the one or more signals received by the external module comprise a plurality of mm-wave signals received by the plurality of antenna elements.
